(19) United States
(12) Patent Application Publication
(10) Pub. No.: US 2013/0042204 A1
(43) Pub. Date: Feb. 14, 2013

(54) AUTOMATIC DATA ENTRY TO AN AUTOMATED RESPONSE SYSTEM (ARS)

(71) Applicant: Patrick Derks, Seattle, WA (US)

(72) Inventor: Patrick Derks, Seattle, WA (US)

(73) Assignee: MICROSOFT CORPORATION, Redmond, WA (US)

(21) Appl. No.: 13/206,593

(22) Filed: Aug. 10, 2011

(51) Int. Cl. H04W 4/00; G06F 3/048

(52) U.S. Cl. 715/810; 455/414.1

(57) ABSTRACT

A method for reporting a credit card loss using a mobile communication device includes prompting a user to select from among two or more formats (e.g., DTMS and speech) a format in which a loss report is to be sent to an automated response system (ARS). The user selects one of the formats and the mobile communication automatically accesses the requested information, generates the loss report in the selected format and outputs it to the ARS.

### BACKGROUND

When credit card holders lose their credit cards they generally report the credit card loss to the credit card company, often using their mobile communication device, in order to prevent unauthorized use of the credit cards.

In a typical reporting process, upon recognizing the loss of a credit card, the credit card holder directly inputs a telephone number of a related credit card company or presses a corresponding shortcut key on a mobile communication device to access an Automated Response System (ARS) of the credit card company. After accessing the ARS, the card holder inputs user information which is used for eligibility verification purpose, such as a resident registration number or a credit card number. The information is typically provided to the ARS via a numeric keypad or via voice. Then, the card holder reports the credit card loss according to the voice information provided by the ARS.

When reporting the loss by using a mobile phone, the card holder has to first access the ARS of the credit card company by placing a telephony call and then directly input all the data requested by the voice information provided by the ARS. If a wallet containing two or more credit cards is lost or stolen, the card holder repeats the loss report process for each card, which can quickly become a tedious process. This is particularly true if the card holder has to locate the credit card information on the mobile communication device itself since this may require switching back and forth between the phone application and the application containing the credit card information. If the information is too lengthy for the card holder to remember it in its entirety, the card holder may need to switch back and forth multiple times.

### SUMMARY

In some implementations, an application residing on a mobile communication device accesses credit card information stored in the device and prepares a credit card loss report based on the credit card information. The credit card report will typically include the credit card number, and possibly other information that is needed by the credit card company. When the user indicates that the report is to be sent to an ARS associated with the credit card company (such as after initiating a call to the ARS), the application gathers the information that the particular ARS will need included in the loss report (which has been pre-provisioned in the mobile communication device by the user) and tailors it in a suitable format so that it can be transmitted and understood by the ARS. Among other requirements, in one particular implementation the ARS requires the loss report to be sent in either a DTMS signal format or a speech signal format and thus the application is configured to format and send the loss report in either format.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows one example of an operating environment in which a process for reporting the loss of credit card information may be implemented.

FIG. 2 is a block diagram illustrating one example of a mobile communication device for reporting credit card loss.

FIG. 3 shows one example of the peripherals interface that may be employed in the mobile communication device of FIG. 2.

FIG. 4 is a flowchart showing one example of a method for reporting the loss of a credit card.

FIGS. 5a-5d show various illustrative menus that may be provided by a user interface employed in the mobile communication device of FIG. 2.

### DETAILED DESCRIPTION

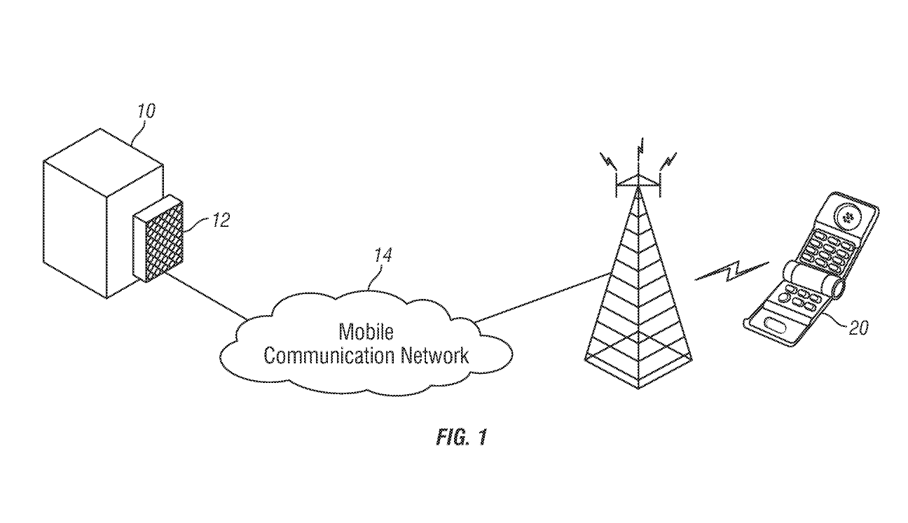

FIG. 1 shows one example of an operating environment which a process for reporting the loss of credit card information as described herein may be implemented. As shown, a user who lost a credit card may call a related credit card company 10 using a mobile communication device 20 in order to access an Automated Response System (ARS) 12 of the credit card company 10 through a mobile communication network 14. In this particular example the user places a wireless telephony call to the ARS 12.

When the access is successful, the ARS 12 outputs voice information to the mobile communication device 20. The user listens to the ARS voice information outputted through a speaker of the mobile communication device 20 and manually inputs all requested data such as, for example, a resident registration number or credit card number of the user, or a service selection number, by directly pressing keys on a keypad. In some conventional arrangements, instead of being manually entered, the mobile communication device 20 recognizes the voice information provided by the ARS 12, and automatically sends the requested data to the ARS. According to one aspect of the present invention, however, a less process-intensive arrangement may be used in which the user establishes the communication session with the ARS 12 and communicates any pertinent service selection information without the need to automatically recognize the voice information received from the ARS 12.

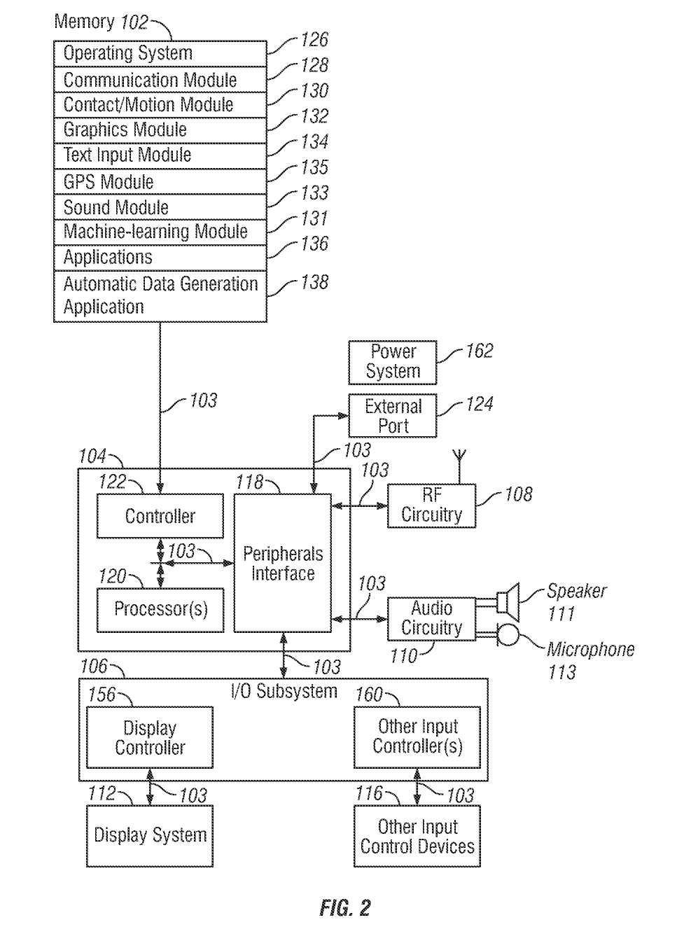

FIG. 2 is a block diagram illustrating one example of a mobile communication device 100 for reporting credit card loss. In some examples the device is a mobile communications device such as a wireless telephone that also contains other functions, such as PDA and/or music player functions. To that end the device may support any of a variety of applications, such as a telephone application, a video conferencing application, an e-mail application, an instant messaging application, a blogging application, a digital camera application, a digital video camera application, a web browsing application, a digital music player application, and/or a digital video player application. While the example in FIG. 2 is depicted as a mobile communications device, the computing device more generally may by any of a wide variety of different devices such as a laptop computer, a tablet computer, a smart phone and a netbook, for example.

The device 100 includes a memory unit 102 (which may include one or more computer readable storage media), a memory controller 122, one or more processors (CPU's) 120, a peripherals interface 118, RF circuitry 108, audio circuitry 110, a speaker 111, a microphone 113, an input/output (I/O) subsystem 106, other input or control devices 116, and an external port 124. These components may communicate over one or more communication buses or signal lines 103.

It should be appreciated that the device 100 is only one example of a mobile communications device 100 and that the device 100 may have more or fewer components than shown, may combine two or more components, or a may have a different configuration or arrangement of components. The various components shown in FIG. 1 may be implemented in hardware, software or a combination of both hardware and software, including one or more signal processing and/or application specific integrated circuits.

Memory unit 102 may include high-speed random access memory and non-volatile memory, such as one or more magnetic disk storage devices, flash memory devices, or other non-volatile solid-state memory devices. Access to memory unit 102 by other components of the device 100, such as the processor 120 and the peripherals interface 118, may be controlled by the memory controller 122. The peripherals interface 118 couples the input and output peripherals of the device to the CPU 120 and memory unit 102. The one or more processors 120 run or execute various software programs and/or sets of instructions stored in memory unit 102 to perform various functions for the device 100 and to process data. In some examples the peripherals interface 118, the CPU 120, and the memory controller 122 may be implemented on a single chip, such as a chip 104. In other examples they may be implemented on separate chips.

The RF (radio frequency) circuitry 108 includes a receiver and transmitter (e.g., a transceiver) for respectively receiving and sending RF signals, also called electromagnetic signals. The RE circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RE circuitry 108 may communicate with networks, such as the Internet, also referred to as the World Wide Web (WNW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from audible signals (i.e., sound waves). The speaker 111 and microphone 113 are two examples of audio transducers that may be employed in the mobile communications device. The audio circuitry 110 converts the electrical signal to audio data and transmits the audio data to the peripherals interface 118 for processing. Audio data may be retrieved from and/or transmitted to memory unit 102 and/or the RF circuitry 108 by the peripherals interface 118. In some embodiments, the audio circuitry 110 also includes a headset jack (not shown). The headset jack provides an interface between the audio circuitry 110 and removable audio input/output peripherals, such as output-only headphones or a headset with both output (e.g., a headphone for one or both ears) and input (e.g., a microphone).

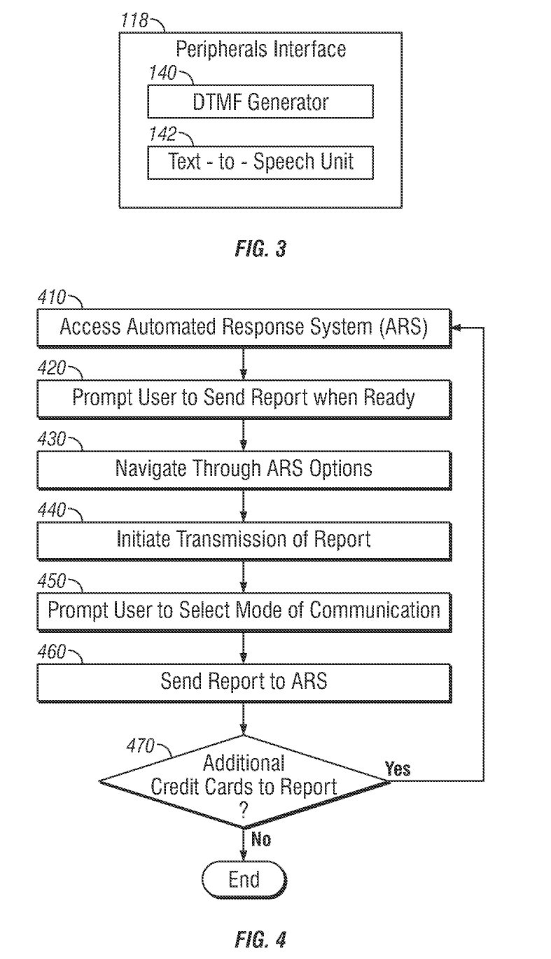

As shown in FIG. 3, peripherals interface 118 may include a DTMF generator 140 and a text-to-speech unit 142. DTMF generator 140 generates and outputs a DTMF (Dual Tone Multi-Frequency) signal. More specifically, the DTMF generator 140 may be used to generate information requested by the ARS 12 in form of a DTMF signal, and outputs the generated DTMF signal to the RF circuitry 108. Likewise, the text-to-speech unit 142, can generate information requested by the voice information of the ARS 12 in form of a speech data, and outputs the data to the RE circuitry 108. The information provided to the DTMF generator 140 and the text-to-speech unit 142 which is converted to a DTMF signal and speech data, respectively, may be stored in memory unit 102, and read out and extracted under the control of controller 122.

DTME generator 140 and the text-to-speech unit 142 represent two examples of a data formatter that accesses from memory the information needed by the ARS and converts it into a format appropriate for transmission over a telephony call. Of course, in some implementations other types of data formatters may be employed as well, depending on the type of call that is placed and the manner in which the ARS operates.

Referring again to FIG. 2, the I/O subsystem 106 couples input/output peripherals on the device 100, such as the display screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some examples input controller(s) 160 may be coupled to any (or none) of the following: a keyboard, infrared port, USB port, and a pointer device such as a mouse.

The display screen 112 provides an input interface and an output interface between the device and a user. The display controller 156 receives and/or sends electrical signals from/to the display screen 112. The display screen 112 displays visual output to the user. The visual output may include graphics, text, icons, video, and any combinations thereof (collectively termed “graphics”).

The display screen 112 will generally include a suitable display such as an OLED display, PLED display, active matrix liquid crystal display, passive matrix liquid crystal display, electrophoretic display, cholesteric liquid crystal display, polymer dispersed liquid crystal and nematic liquid crystal display. In some implementations the display screen 112 may be a touch-screen display.

The device 100 also includes a power system 162 for powering the various components. The power system 162 may include a portable power supply (e.g., battery) and components employed to receive power from an alternating current (AC) source, a power management system, a recharging system, a power failure detection circuit, a power converter or inverter and any other components associated with the generation, management and distribution of power in portable devices.

In some embodiments, the software components stored in memory unit 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, a sound module 133 (or set of instructions) and applications (or set of instructions) 136.

The operating system 126 (e.g., Darwin, RTXC, LINUX, UNIX, OS X, Microsoft WINDOWS®, Android or an embedded operating system such as VxWorks) includes various software components and/or drivers for controlling and managing general system tasks (e.g., memory management, storage device control, power management, etc,) and facilitates communication between various hardware and software components. The communication module (or set of instructions) 128 facilitates communication with other devices over one or more external ports 124 and also includes various software components for handling data received by the RF circuitry 108 and/or the external port 124 (e.g., Universal Serial Bus (USB), FIREWIRE, etc.).

The graphics module 132 includes various known software components for rendering and displaying graphics on the display screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. The text input module (or set of instructions) 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and may provide this information for use in various applications (e.g., applications that provide location-based services such as weather widgets, local yellow page widgets, and map/navigation widgets).

The applications 136 may include any combination of the following illustrative modules; a contacts module, a telephone module; a video conferencing module; an e-mail client module an instant messaging (IM) module; a blogging module; a camera module; an image management module; a video player module; a music player module; a browser module; a word processing module; a voice recognition module; a calendar module; widget modules, which may include a weather widget, stocks widget, calculator widget, alarm clock widget, dictionary, widget, and other widgets obtained by the user, as well as user-created widgets.

One particular application that is illustrated in FIG. 2 is an automatic data generation application 138. As explained in more detail below, the application accesses credit card information stored in the mobile communication device and prepares a credit card loss report based on the credit card information. The credit card report will typically include the credit card number, and possibly other information that is needed by the credit card company. When the user indicates that the report is to be sent to an ARS associated with the credit card company, the application gathers the information that the particular ARS will need included in the loss report (which has been pre-provisioned in the mobile communication device by the user) and tailors it in a suitable format so that it can be transmitted and understood by the ARS. Among other requirements, the ARS typically will require the loss report to be sent in either a DTMS signal format or a speech signal format.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory, unit 102 may store a subset of the modules and data structures identified above. Furthermore, memory unit 102 may store additional modules and data structures not described above.

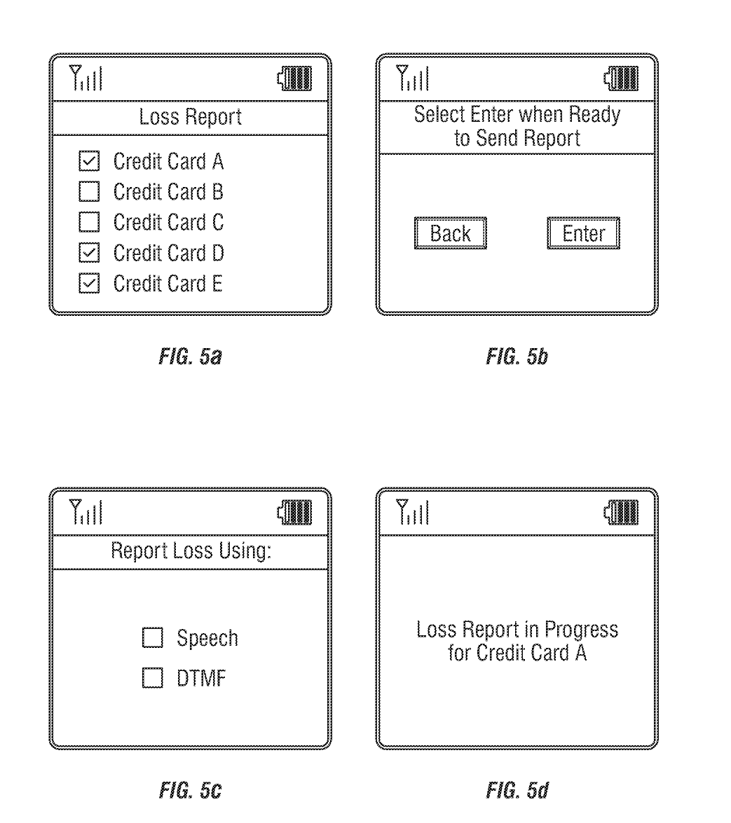

FIG. 4 is a flowchart showing one example of a method for reporting the loss of a credit card using, for example, the aforementioned application 138 residing on the mobile communication device. To initiate the report process, the user first accesses the ARS 12 of the appropriate credit card company 10 at step 410. The user may do this manually, such as by entering a telephone number, for example. Alternatively, the application 138 may automatically establish communication with the ARS 12 as part of the credit card loss process. In this latter case the user may first access the automatic data generation application 138, which may provide a user interface such as illustrated in FIG. 5a.

As illustrated in FIG. 5a, the mobile communication device provides an interface or menu 500 for generating the credit card loss report. If the user has multiple credit cards, the interface or menu 500 allows the user to select the particular credit card that is to be reported. In this example the user has selected credit card D. If at step 410 the application 138 automatically establishes communication with the ARS 12, then upon selecting credit card D, the mobile communication device begins to dial the phone number for the appropriate credit card company to initiate a telephony call or establish communication in any other suitable manner. In this case the user has previously manually entered the appropriate phone number or other contact information for the credit card company.

Returning to FIG. 4, once communication with the credit card company has been established, either manually or automatically, the user is prompted by the application 138 to send the loss report to the ARS 12. FIG. 5b shows one example of a user interface that may be presented to the user in order to prompt the user to send the loss report.

Before sending the loss report, the user at step 430 may in some cases need to navigate through various service selection numbers or other options that may be presented to the user by the ARS 12. For instance, the ARS 12 may ask the user to press “1” in order to report a lost credit card.

Once the ARS 12 is ready to receive the information, the user selects the “enter” icon on the menu of FIG. 5b at step 440 in order to initiate the transmission of the loss report to the ARS 12. In response, the application 138 presents another interface or menu at step 450, which prompts the user to select the format in which the loss report is to be communicated. As shown in FIG. 5c, in this example the user is presented with two option: speech and DTMS. The format in which the report is sent will depend on whether the ARS 12 prompts the user to use a DTMF-based data entry process or a speech-based data entry process. The mobile communication device sends the loss report at step 460.

While the information in the loss report is being sent to the ARS 12, the application 138 may present an interface screen such as shown in FIG. 5d, which displays a message indicating that transmission of the loss report is in progress. In addition, or instead of the indicating that transmission is in progress, the application may present an interface screen which displays a message indicating that the transmission of the loss report is complete.

Upon completing the report for one lost credit card, the mobile communication device determines at step 470 whether the user wishes to select another credit card to be reported. If so, the mobile application 138 will return to step 410 to repeat the loss report process for the next credit card. If not, then the process terminates at step 480.

In some implementations the automatic data generation application 138 may operate in conjunction with, or even be a part of, an electronic wallet application that may reside on the mobile communication device. Electronic wallet applications are generally capable of storing a wide variety of different types of payment accounts. The user only needs to enter the information into the payment accounts once, yet can be used to make purchases from a wide variety of different vendors. Such information typically includes credit card information (e.g., credit card numbers, security information such as CVN codes, expiration dates), login and password information, and possibly other personal information. Accordingly, the electronic wallet will include much if not all of the information needed to report the loss of one of the credit cards to the credit card company. Thus, the functionality of the automatic data generation application can be included with the electronic wallet application and, in some cases, may provide an integrated series of menus or interfaces of the type discussed above that are included with the menus and interfaces provided by the electronic wallet.

In the examples presented above the information that is automatically transmitted to the ARS is credit card information used to report a lost credit card. More generally, however, the methods, techniques, systems and devices described herein may be used to report other types of information to an ARS using a mobile communication device. The information sent to the ARS will generally be accessible to the mobile communication device from memory, thus eliminating the need for the user to manually enter the information after establishing the telephony call.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for reporting a credit card loss using a mobile communication device, comprising:
prompting a user to select from among a plurality of formats a format in which a loss report is to be sent to an ARS;
receiving a user response selecting a first of the formats; and
outputting the loss report in the first format.

2. The method of claim 1 in which the plurality of formats include a DTMF signal format and a speech signal format.

3. The method of claim 1 further comprising prompting the user to initiate a loss reporting process by establishing communication with the ARS.

4. The method of claim 3 in which the communication with the ARS is established by the mobile communication device via a telephony call and further comprising outputting the loss report from the mobile communication device so that the loss report is transmitted to the ARS over the telephony call.

5. The method of claim 1 in which prompting the user includes displaying a menu from which the user selects from among the plurality of formats.

6. The method of claim 1 further comprising displaying a menu that includes a list of credit cards and in response receiving user input selecting a credit card whose loss is to be reported.

7. The method of claim 6 further comprising accessing a memory to retrieve information associated with the selected credit card and generating the loss report using the information that is retrieved.

8. The method of claim 1 further comprising automatically establishing communication with the ARS in response to a user request.

9. The method of claim 8 further comprising accessing a menu in the mobile communication device to retrieve a telephony number of the ARS and automatically contacting the ARS using the telephone number.

10. One or more computer-readable storage media containing instructions which, when executed by one or more processors, perform a method for communicating information to an ARS using a mobile communication device, comprising:
establishing a communication session with the ARS using the mobile communication device;
prompting a user to select from among a plurality of formats a format in which the information is to be sent to an ARS;
receiving a user response selecting a first of the formats;
accessing a memory associated with the mobile communication device to retrieve the information to be communicated to the ARS;
transmitting the information to the ARS from the mobile communication device during the communication session;

11. The computer-readable storage media of claim 10 in which the communication session is established by the mobile communication device via a telephony call and further comprising transmitting the information from the mobile communication device to the ARS over the telephony call.

12. The computer-readable storage media of claim 10 wherein the information includes credit card information used to report a loss of a credit card to a credit card company associated with the ARS.

13. The computer-readable storage media of claim 12 further comprising displaying a menu that includes a list of credit cards and in response receiving user input selecting a credit card whose loss is to be reported.

14. The computer-readable storage media of claim 13 further comprising accessing a memory to retrieve information associated with the selected credit card and generating the loss report using the information that is retrieved.

15. The computer-readable storage media of claim 10 in which prompting the user includes displaying a menu from which the user selects from among the plurality of formats.

16. A mobile communications device, comprising:
a transmitter and receiver for respectively sending and receiving RF signals;
at least one memory unit;
a display screen;
a user interface for receiving user input;
at least one data formatter for providing information accessed from the memory unit in a format that can be communicated via, a telephony call;
a processor operatively associated with the transmitter, receiver, memory unit, display screen, user interface and at least one data formatter, wherein the processor is configured to (i) display a menu on the display screen requesting a user to select from among a plurality of formats a format in which information is requested by an ARS; (ii) receive a user response selecting a first of the formats; (iii) retrieve the information from the memory unit; and (iv) cause the data formatter to access the information and provide the information to the transmitter in the first format so that the information can be communicated over a telephony call to the ARS.

17. The mobile communications device of claim 16 in which the plurality of formats include a DTMF signal format and a speech signal format.

18. The mobile communications device of claim 16 in which the data formatter is DTMS generator.

19. The mobile communications device of claim 16 in which the data formatter includes a DTMS generator and a text-to-speech unit.

20. The mobile communications device of claim 19 in which the processor is further configured to cause either the DTMS generator or the text-to-speech unit to access the information and provide it to the transmitter based on the user response selecting the first of the formats.
